(19) United States
(12) Patent Application Publication
(10) Pub. No.: US 2007/0122780 A1
(43) Pub. Date: May 31, 2007

(54) Systems and methods for support of behavioral modification coaching

(75) Inventors: Darrell T. Moon, Draper, UT (US); Kip Massey, Salt Lake City, UT (US)

Correspondence Address: MORRISS O''BRYANT COMPAGNI, P.C., 734 EAST 200 SOUTH, SALT LAKE CITY, UT, 84102, US

(73) Assignee: Behavioral Health Strategies of Utah, LLC

(21) Appl. No.: 11/590,623

(22) Filed: Oct. 31, 2006

Related U.S. Application Data
(60) Provisional application No. 60/732,410, filed on Oct. 31, 2005.

(51) Int. Cl. G09B 19/00

(52) U.S. Cl. 434/236

(57) ABSTRACT

Methods and systems related to providing cost effective behavioral modification and coaching support for individuals. Individuals that are identified as being at risk for being chronically ill or high utilizers of health care services and as motivationally challenged may be targeted for contact by coaches trained in behavioral modification. By using a computer-based system for tracking the individual's progress with respect to any number of goals, which may include both health care related goals and non-health related goals desired by the individuals, the motivation of the individuals may be increased. The attitudinal change brought by the visible tracking of successful goals may lead to increased compliance with health care related goals and a decreased usage of health care services.

### CROSS-REFERENCE TO RELATED APPLICATION

This application claims the benefit of U.S. Provisional Application No. 60/732,410, filed Oct. 31, 2005, which is incorporated herein by reference in its entirety.

### TECHNICAL FIELD

The present invention relates generally to systems and methods for providing behavioral modification coaching and support. More particularly, the present invention relates to systems and methods for providing behavioral modification coaching and support in a way that provides efficient and real-time information to coaches and/or participants.

### BACKGROUND

Disease management techniques have been tried to reduce health care costs for chronically ill patients. Problems encountered with providing such techniques to the individuals who would benefit therefrom involve both motivating the chronically ill to make changes in their lifestyle that would reduce their need for health care and the costs of providing individualized service to effectuate such change.

Attempts to provide individuals with computerized support to effectuate change have typically had issues being successful due to the “sterile” nature of the interaction, which lacks the personal warmth and emotional support that comes from interacting with a therapist or other behavioral coach.

It is possible to identify individuals covered by an insurance plan that are chronically ill and account for a larger proportion of the total costs of the plan compared to the per capita plan average. Attempts to target and provide behavioral modification supports to these individuals have experienced the types of problems discussed above, or have been considered to be cost prohibitive.

One type of attempt to provide targeted incentives to encourage individuals to improve their health status is detailed in U.S. Patent Application Publication US 2005/0228692 and U.S. Patent Application Publication U.S. 2005/0234742, each of which is entitled “Incentive Based Health Care Insurance Program” and each of which is incorporated by reference herein in its entirety. Under such incentive based plans, an incentive is provided to a plan participant in exchange for improving, achieving or maintaining a desired core on a “health risk assessment” tool. Such plans may fail to induce real change for participants, and thus generate cost savings, as the direct tie of the incentive to the health care issue often fails to motivate individuals in need of change to focus on the change process itself and achieve successful outcomes. Further, such plans are offered as a complete “add-on” package having only a single package of benefits and features, and are not customizable for individual implementations.

Prior to development of the present invention, a behaviorally oriented disease management program was used to target 2% of the membership of a health plan sponsored by a Utah county government. This 2% was identified as being responsible for 18% of the county's health care expenses in prior years. Using telephonic contacts made by coaches, these individuals were provided with behavioral modification support. Within a period of 2-3 months, the targeted participants showed an immediate reduction in claims with a significant reduction occurring on an average of 18 to 24 months. Over a three year period there was an average total decrease in health care costs of 53% for the targeted participants. For a five year period, the total increase in expenses for the county health plan as a whole amounted to 0.4% as opposed to a national average increase of 11%, resulting in an ROI of 4 to 1 for the county. Based on this cost savings, there is clearly a need to provide such programs to larger populations in a cost effective manner.

A system or method of cost effectively providing behavioral modification coaching would be an improvement in the art. Such a method or system that was capable of targeting “high-risk” individuals in order to reduce health care costs would similarly constitute an improvement in the art. Similarly, such a method or system that was able to provide flexible benefits to users as desired by the insurer would also constitute an improvement in the art.

### SUMMARY

The present invention includes methods and systems related to providing cost effective behavioral modification and coaching support for individuals. In one illustrative embodiment, individuals covered by participating insurance plans are identified as being at risk for being chronically ill or high utilizers of health care services. Individuals falling within this group that are identified as motivationally challenged may be targeted for contact by coaches trained in behavioral modification. By using a computer-based system for tracking the individual's progress with respect to any number of goals, which may include both health care related goals and non-health related goals desired by the individuals, the motivation of the individuals may be increased. The attitudinal change brought by the visible tracking of successful goals may lead to increased compliance with health care related goals and a decreased usage of health care services.

In another illustrative embodiment, all individuals covered by participating insurance plans may be eligible for behavioral modification support using a system in accordance with the present invention. By using a computer-based system for tracking the individual's progress with respect to any number of goals, which may include both health care related goals and non-health related goals desired by the individuals, the motivation of the individuals may be increased or maintained to result in overall increases in compliance with health care related goals and a decreased usage of health care services. Embodiments of the present invention may include flexibility with respect to the specific levels of services offered or triggering factors for various services, to allow the payor to determine the costs per participant of the system in order to achieve desired results while reducing costs of offering the system.

### DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims, and to the several drawings.

FIG. 1 is a box diagram illustrating one possible embodiment of a participant tracking computer system in accordance with one aspect of the present invention.

FIG. 2 is a flowchart illustrating some possible interactions of an individual participant with a system in accordance with the present invention.

FIG. 2A is a depiction of a webpage-like interface illustrating one possible embodiment of an implementation of a process as explained in connection with FIG. 1.

FIG. 3 is a flowchart illustrating some possible interactions of an individual participant in creating goals to be tracked by a system in accordance with the present invention.

FIG. 4 is a flowchart illustrating some possible interactions of an individual participant in tracking goals with a system in accordance with the present invention.

FIG. 5 is a flowchart illustrating some possible interactions of an individual participant in viewing the progress made on goals using a system in accordance with the present invention.

FIG. 6 is a flowchart illustrating some possible interactions of an individual participant in recovering a lost username or password for a system in accordance with the present invention.

FIG. 7 is a flowchart illustrating some possible interactions of a behavioral modification coach with a system in accordance with the present invention.

FIG. 8 is a flowchart illustrating some possible interactions of an administrator with a system in accordance with the present invention.

FIG. 9 is a flowchart illustrating some possible interactions of an administrator in searching and analyzing participant data with a system in accordance with the present invention.

FIG. 10 is a flowchart illustrating some possible interactions of an administrator in analyzing and monitoring participant data with a system in accordance with the present invention.

FIG. 11 is a flowchart illustrating some possible interactions of an administrator in analyzing and modifying reminders and schedules with a system in accordance with the present invention.

FIG. 12 is a flowchart illustrating some possible interactions of an administrator in analyzing and modifying health plan information with a system in accordance with the present invention.

FIG. 13 is a flowchart illustrating some possible interactions of an administrator in analyzing and modifying condition data with a system in accordance with the present invention.

FIG. 14 is a flowchart illustrating some possible interactions of an administrator in analyzing and presenting information including score sheets with a system in accordance with the present invention.

FIG. 15 is a flowchart illustrating some possible interactions of a system user in creating an internal message to another user using a system in accordance with the present invention.

### DETAILED DESCRIPTION

The present invention relates to systems and methods for providing participant tracking and data management for use in behavioral modification protocols and regimens. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. For example, it will be appreciated that the methods and systems discussed herein, while particularly suited for support for high risk individuals in health care related behavioral modifications may be easily adapted to provide support for other individuals in relation to virtually any type of goal or outcome for which coaching support may provide benefits. All such alternate embodiments are within the scope of the present invention.

Participants for the present invention may be selected by any number of methods. For example, any individual desiring support in a behavioral modification endeavor could contact an agency offering the system and subscribe thereto. Alternatively, a health insurance plan or an employer could offer the system as a benefit to subscribers or employees, as part of an effort to save on health care costs. In some such embodiments, the potential participants could be screened, as by reviewing past usage of health care services or by the application of a health assessment survey to the participants. Participants who are identified as having high health care service usage (or likely to have high health care service usage) and/or participants that are identified as having motivational challenges may be identified and contacted by coaches employed by the system to begin participation. For example, a health risk appraisal may be conducted, which could be administered as a questionnaire or an interview. Alternatively, biometric health screenings for indicators of health concern, such as high blood pressure, high body fat percentage, high body mass index, high cholesterol, high glucose, or high triglycerides may be conducted.

In other embodiments of the present invention, the system may be offered to all participants, such as all employees of an employer seeking to offer the system in conjunction with a health insurance plan. This system may be offered as part of a bona fide wellness program, under the applicable HIPAA rules. In such embodiments, the participants may be offered a discount on the price of the insurance or another incentive in order to encourage participation. As will be explained further herein, the particular benefits offered and costs may be individually tailored for the desired implementation.

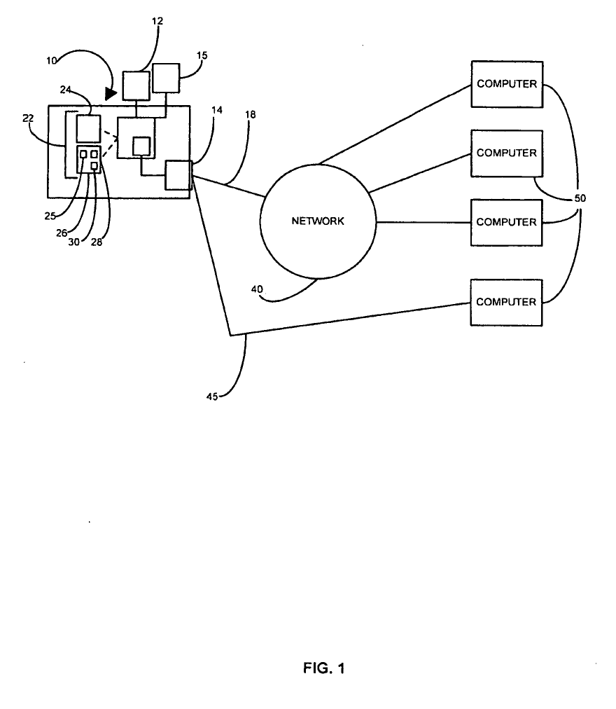

Referring to FIG. 1, one possible embodiment of the computer based portion of a system in accordance with the present invention is depicted, including a participant tracking computer system 10 for carrying out a portion of the methods and processes of the present invention. It will be appreciated that although participant tracking computer system 10 is depicted as a single computer for simplicity, any number of different computers functioning to act as a single system for carrying out the processes or methods described herein may be used and is within the scope of the present invention. Participant tracking computer system 10 may include or function as a Web interfacing system (e.g., a Web server) for enabling access and interaction with other devices linked to local and external communication networks (“networks”), including the World Wide Web (the “Internet”), a local area network (LAN), a wide area network (WAN), an intranet, the computer network of an online service, etc. Participant tracking computer system 10 optionally may include one or more local displays 15, which may comprise a conventional monitor, a monitor coupled with an integrated display, an integrated display (e.g., an LCD display), or other means for viewing data or processing information. One or more interface modules may also be present to support input and output between a user and the participant tracking computer system 10 through an interface device 12 such as a joystick, keyboard, mouse or data glove. Participant tracking computer system 10 may also include a network interface (I/O) 14 for bidirectional data communication through one or more and preferably all of the various networks (LAN, WAN, Internet, etc.) using communication paths or links known in the art, including wireless connections, ethernet, bus line, Fibre Channel, ATM, standard serial connections, and the like.

Still referring to drawing FIG. 1, participant tracking computer system 10 includes one or more microprocessors 20 responsible for controlling all aspects of the computer system. Thus, microprocessor 20 may be configured to process executable programs and/or communications protocols which are stored in memory 22. Microprocessor 20 is provided with memory 22 in the form of RAM 24 and/or hard disk memory 26 and/or ROM (not shown). As used herein, memory designated for temporarily or permanently storing one or more participant tracking protocols on hard disk memory 26 or another data storage device in communication with participant tracking computer system 10 is referred to as participant tracking database 25. Participant tracking database 25 may be configured in any suitable method known to those of ordinary skill in the art, for example as a MS SQL database. Similarly, memory designated for temporarily or permanently storing one or more interfaces generated by or utilized by participant tracking computer system 10 on hard disk memory 26 or another data storage device in communication with participant tracking computer system 10 is referred to as interface database 30.

In one embodiment of the present invention, participant tracking computer system 10 uses microprocessor 20 and the memory stored protocols to exchange data with other devices/users on one or more of the networks via Hyper Text Transfer Protocol (HTTP) and Simple Mail Transfer Protocol (SMTP), although other protocols such as File Transfer Protocol (FTP), Simple Network Management Protocol (SNMP), and Gopher document protocol may also be supported. Webpage-like interfaces with the remote computers 50 may thus be used. Participant tracking computer system 10 may further be configured to send and receive HTML formatted files. In addition to being linked to a local area network (LAN) or wide area network (WAN), participant tracking computer system 10 may be linked directly to the Internet via network interface 14 and communication links 18 attached thereto, or be capable of linking directly to a remote computer 50 (as will be discussed further herein).

Participant tracking computer system 10 will preferably contain executable software programs stored on hard disk 26 related to the operation of a Web server. Hard disk 26 may also contain specific software programs relating to the participant tracking and data management functions, as in participant tracking database 25. Alternatively, a separate hard disk, or other storage device, (not shown) may optionally be provided with the requisite software programs for conducting the methods as described herein.

Participant tracking computer system 10 is able to communicate with remote computers 50. This may be accomplished in any suitable fashion. For example, communication may occur over a network 40, which may include the internet, to which participant tracking computer system 10 is in operative communication via network interface 14 and communications link 18. Alternatively, participant tracking computer system 10 may directly communicate with a remote computer 50, using a direct connection 45 in operative connection with communications link 18, such as a direct dial connection over telephone lines, or another suitable connection.

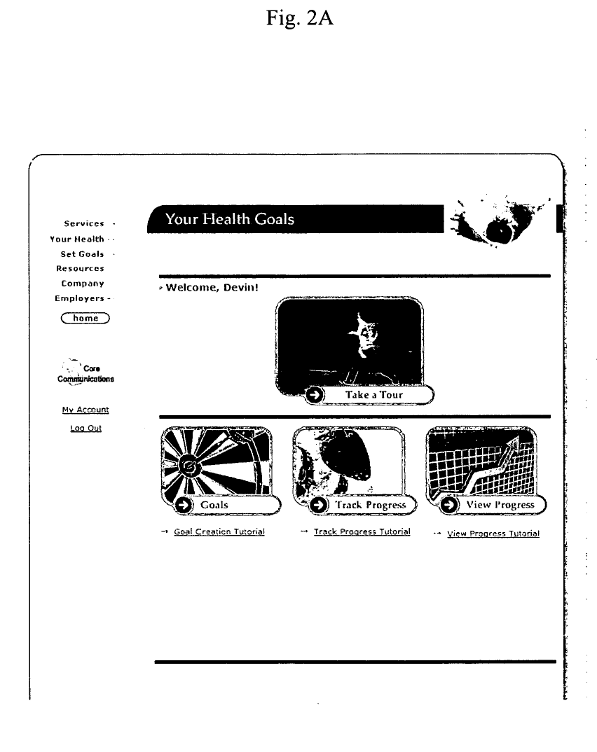

Turning to FIG. 2, a flowchart illustrating some possible interactions of an individual participant with the computer based portion of a system 1 in accordance with the present invention is depicted. The computer based portion of the system may be made available over a network, such as the internet, to the various users (participants, coaches, physicians, etc.) In such embodiments, this may be accomplished by providing the computer based portion of the system as a participant tracking computer system 10, accessed using network 40 by the various users using remote computers 50. In such embodiments, participant data may be kept secure through the use of encryption and password protected access.

As depicted at box 10A, a participant accesses the computer-based portion of the system 1 utilizing a computer 50 to make a connection to the system 1, whether by a direct network connection, a direct dial modem connection, or over the internet. The participant may access the system by interacting with a webpage-like interface, similar to that depicted in FIG. 1A. Where access to the system is provided by interaction with a webpage-like interface, such interfaces may be provided over a network connection from a server running an implementation of the system. In one embodiment, the webpage-like interfaces may be implemented using a scripting language known to those of ordinary skill in the art, such as Cold Fusion™ or Front Page™. Information required to operate the system, including participant information may be maintained in one or more databases. For example, the “shell” of a webpage-like interface may be accessed from interface database 30 and the specific information for a participant displayed therein may be accessed from participant tracking database 25. Any suitable, database format may be used, such as a MS SQL type databases.

Where the participant is utilizing the computer based portion of the system for the first time, the participant may create an account for tracking of data. Where an interface similar to that shown in FIG. 2A is used the participant may select the “new user” command, as by clicking the appropriate button, as depicted in box 20A.

A set of specific information may be required from the user for collection into the computer-based system in order to establish an account. Typically, the participant may be required to provide basic identifying information in order to establish an account. Where the system is provided to participants as a benefit from an employer, as an adjunct to a health insurance policy, or through another sponsor, the identity of the sponsor may be required, as depicted in box 30A and may occur through a pull-down menu on a webpage-like interface. Other information, such as the participant's name, email address, preferred user name and/or password may required, as may demographic information, as depicted in boxes 40A through 60A. All such required information may then be associated with the user and saved in the participant tracking database 25.

The terms and conditions of use of the system may be provided to the participant and the participant's consent to these terms and conditions obtained, as depicted in boxes 70A and 90A, which may occur through webpage-like interfaces. The terms and conditions presented may be just for the access to the computer based portion of the system, or may be for the system 1 as whole, including interactions with coaches, physicians and administrators involved in the system. In such embodiments, the creation of the participant's account may be a triggering event to begin the participant's interaction with the system. In other embodiments, a coach may contact a participant upon the availability of the system to the participant and create an account for the participant, then provide a username and password to the participant.

It will be appreciated that the system may be configured, such that an administrator could create multiple accounts for multiple users at once. For example, a listing of participants could be provided by an employer or insurer offering a version of the system to those participants. The administrator may put in an electronic list of these participant's names, and have the system create accounts for each name on the list. Where each name is associated with an email address, the system may automatically send the login and password information to each participant, allowing them to access the system.

As depicted in box 80A, a participant who is not willing to agree to the terms and conditions may not be able to set up an account.

Once a participant has an account, the participant may log in to the system 1 upon establishing a network connection to a computer 10 hosting the computer based portion of the system. Once the participant logs in, a “home page” interface may be displayed, as depicted in box 100A. From this “home page” the participant may control their account and access some of the features of the system. As shown in boxes 102A through 114A, the participant may be able to edit and update contact information, geographic information, their password or other information associate with their account, all of which information may be maintained in the participant tracking database 25. Webpage-like interfaces may be accessed by the participant to perform such editing or updating.

As depicted in box 116A, one option that may be available to a participant is to review the features available to the participant from the computer-based portion of the system by viewing a series of webpage-like interfaces explaining the system. Such a review could be initiated by clicking a “tour” button” on the “home page” for the participant. Such a tour could further include information on other aspects of the system, including the services provided by the coaches and administrators.

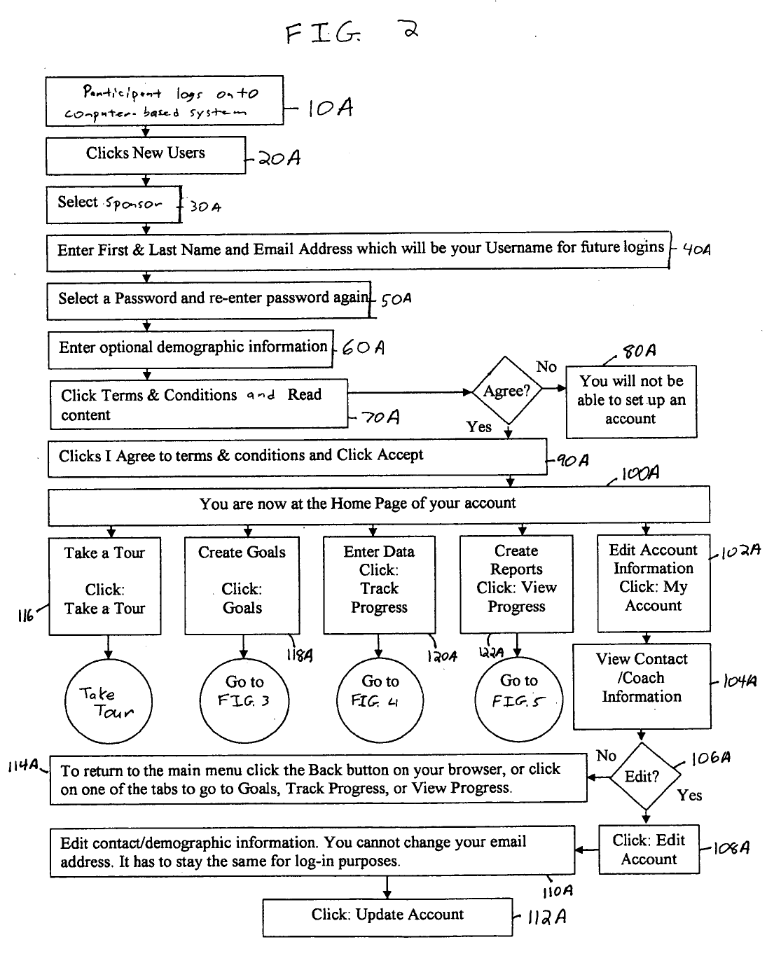

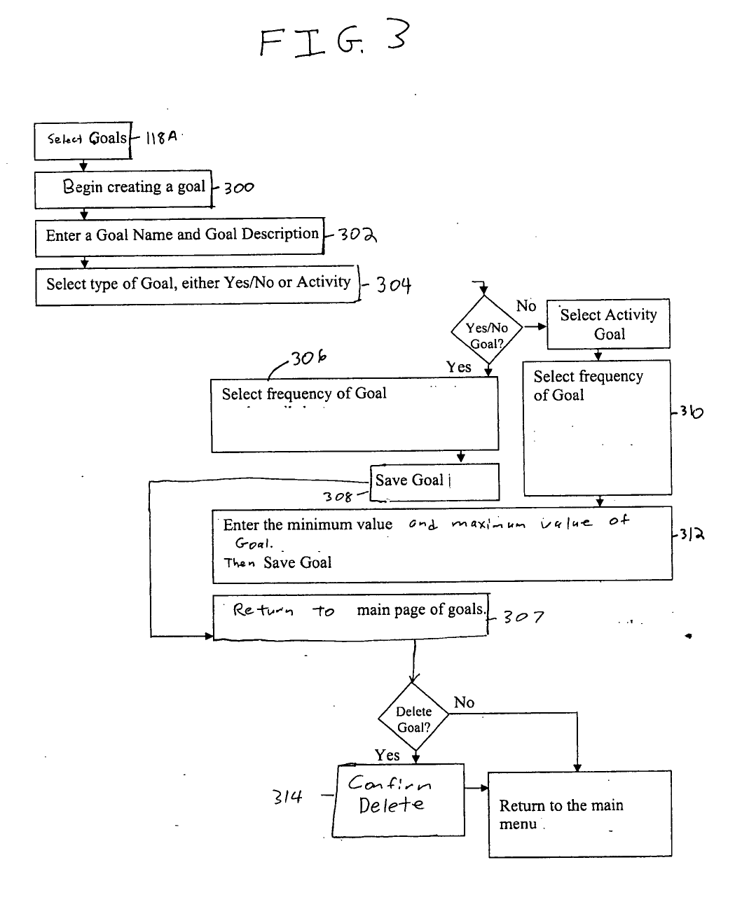

FIG. 3 depicts one embodiment of a process whereby a participant may create a goal which may then be tracked using computer based portion of the system 1. The participant instructs the system to begin the goal creation process, as by clicking a “create goal” button, as depicted in box 118A (FIGS. 1 and 3). The goal creation process may then require the input of information related to the goal by the participant, typically following a prearranged sequence. The participant begins creating the goal by selecting this option, which may be done through a webpage-like interface that allows other goals associated with the participant to be viewed.

The name and/or a description of the goal may be required, as described in box 302. The participant may be required to select whether the goal is to be tracked on a yes/no basis or on a basis of frequency, as shown in box 304. For example, should the participant select a goal of drinking eight glasses of water a day, the goal could be tracked either as a yes/no goal or as a frequency goal. Where the participant opts to track the goal as a yes/no goal, the system may then require the frequency of the goal tracking (daily, weekly, etc.) as depicted in box 306, and the goal may be saved in the computer-based system database, as by clicking a save goal button as depicted in box 308.

Where the goal is selected to be tracked as an activity goal, as depicted in box 310, both the frequency of the tracking and minimum and maximum values of the goals are to be selected, as depicted in boxes 310 and 312, which may occur through webpage-like interfaces. Where the goal is to drink at least eight glasses of water a day, the minimum value may be set at zero and the maximum value set at eight, with the frequency set to daily tracking. Once the frequency is set, the goal may be saved.

Once a new goal is saved, the participant may be returned to the “top page” or goals as depicted in box 307. In some embodiments, the participant may have the option of deleting goals by selecting a delete goal command, as depicted in box 314. It will be appreciated that the ability to delete goals may be limited by the system to just goals set by the participant or to goals that do no affect a particular outcome that the participant requires.

The computer based portion of the system 1 may allow a participant to track their progress, as by selecting a command to track progress, as depicted by box 120A of FIG. 2. Selection of this command may result in the display of a webpage-like interface from which progress may be tracked. One option may be to track progress by a period of time, such as a week. The participant may select a time period, such as a week, to track progress, as depicted in box 400. A list of the available goals may be displayed, and the participant may select or deselect goals for which tracking is desired, as depicted in box 402 or may add a new goal for tracking, as discussed previously herein.

Once goals are selected, a data entry sheet may be displayed, as shown by box 403. This may be another webpage-like interface, which allows the participant to enter data for the goal, such as yes/no or the value (such as the number of glasses of water consumed in a day), and then record the data by commanding the system to retain the data, as by clicking an “update results” button as described in box 404. The participant may also make notes in an electronic journal concerning the goal and progress.

Once the new data is saved, the computer-based system may display a graph (such as a bar graph) of the results for the week and provide the user with the opportunity to revise the data, as depicted in box 406. Where the data was incorrectly entered, the participant may revise the data, as depicted in box 408 and save the revised data, as depicted in box 410. Revisions may be made through a webpage-like interface. Once data is saved, the participant may be returned to the “track progress” page, from which graphs of a week's data may be viewed by selecting the appropriate commands, as depicted in box 412.

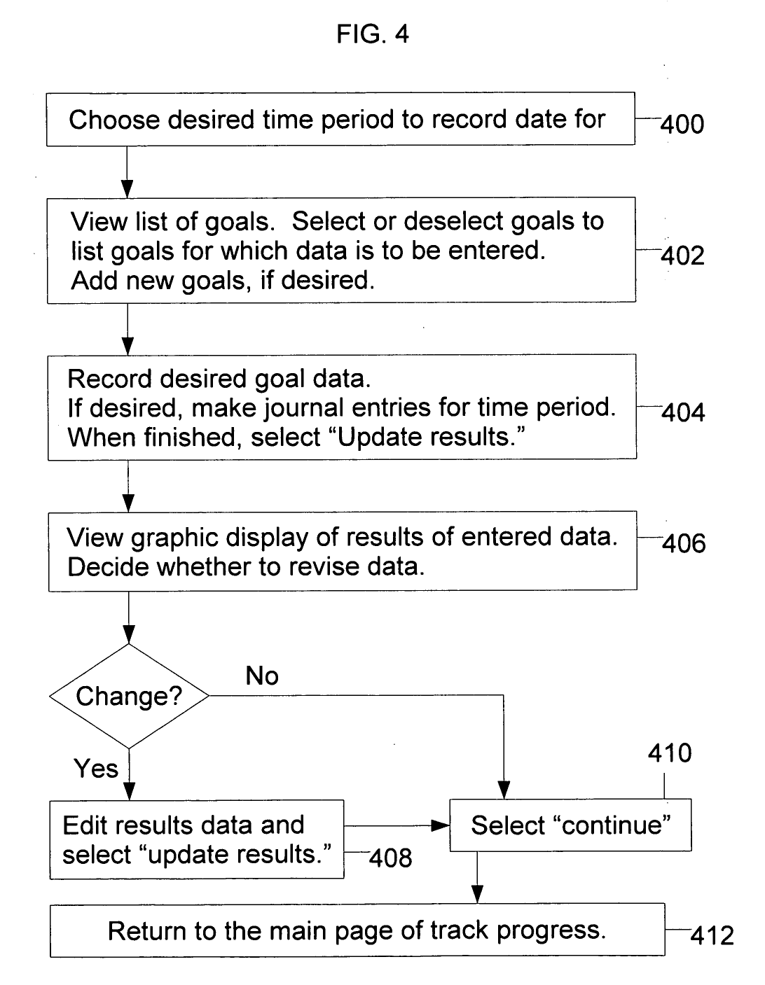

The participant may be able to view their progress in relation to goals tracked by the computer-based portion of the system through a process similar to that depicted in FIG. 5. The participant may select a command to view progress, as by selecting a button on a “home page,” as depicted at box 122 of FIG. 2. Selection of this command may result in the display of a webpage-like interface, from which the participant may select a time frame for viewing the progress of the tracked goals, as depicted in box 500. Where desired, the system may offer the participant the option of viewing a sample progress report, by executing an appropriate command, as depicted in box 502. In some embodiments, the participant may skip viewing a sample report by selecting a next or skip command, as depicted on box 504.

The system may then require the user to designate the tracked goals for which progress is to be viewed. This may occur by presenting a list of goals and requesting the participant to select or deselect the desired goals. The participant may also be required to select a type of graph for display of the tracked data in graphical form. Box 506 depicts mechanisms through which such selections may be made.

Once the appropriate selections are made, a report may be generated, as depicted in box 508. The report may be displayed as a written report or in the form of a graph. Summations, as by consolidated averages over time or by goal may be provided with the report.

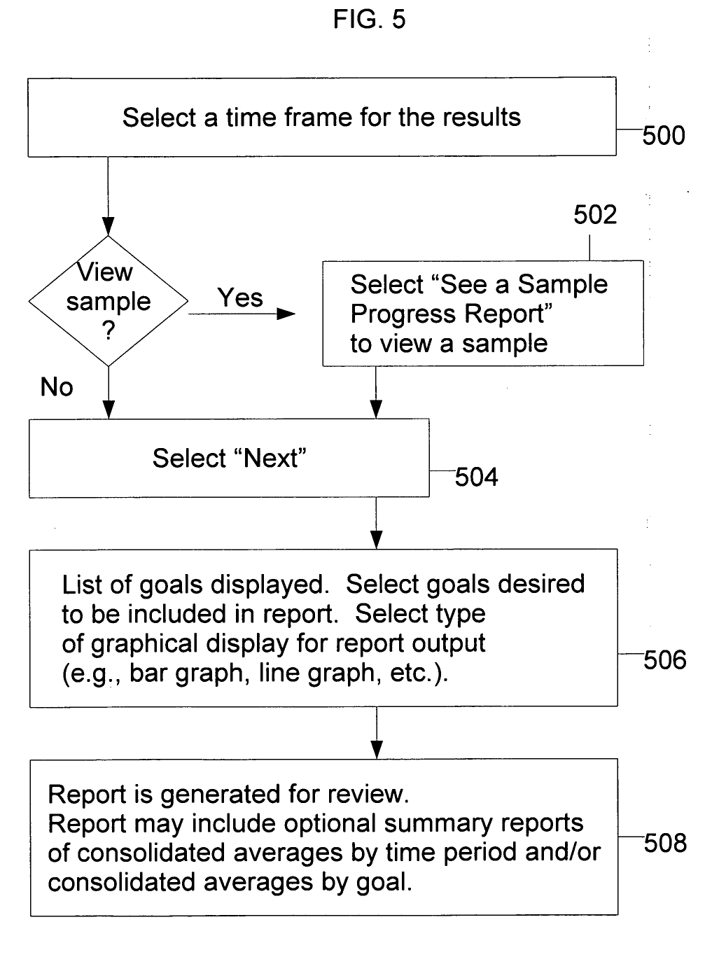

FIG. 6 depicts a process whereby a participant or other user that has lost a password or user name may recover this information to access the system. After accessing the system, as depicted by box 1A (FIG. 2 and FIG. 6), which may display a “home page”, the participant may select a “lost password” option, as illustrated in boxes 600 and 602, or a lost username option, as illustrated in box 604. The system may then request the participant's email address which may be entered and compared to that already in the system. If there is a match, the corresponding username or password is sent to the email address by the system. If not, an error message may be sent, as shown in box 606.

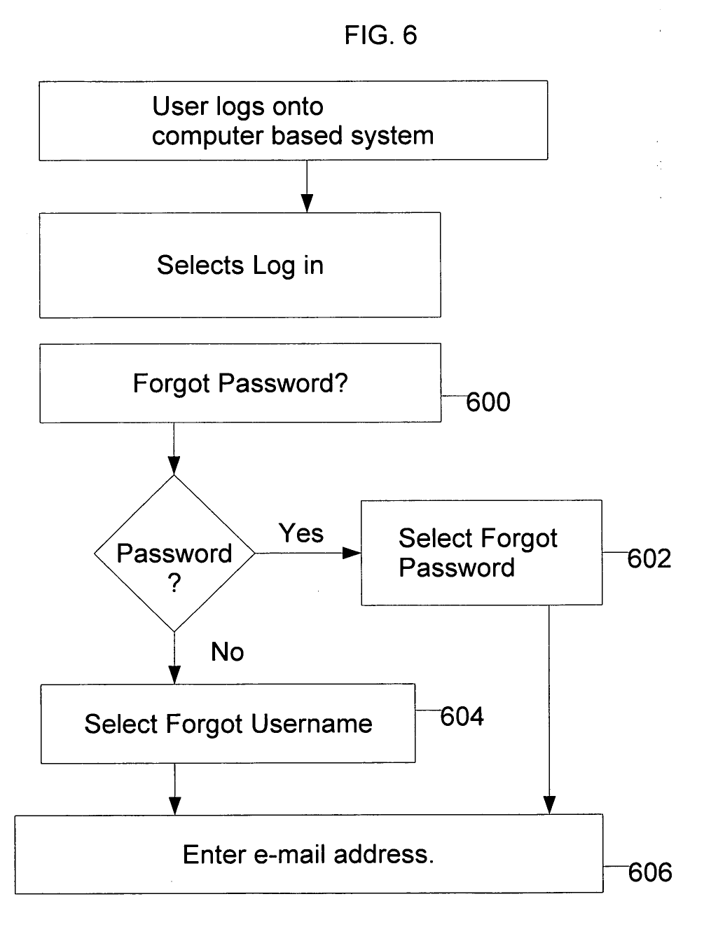

Turning to FIG. 7, a flowchart describing one embodiment of the interaction of a behavior management or “personal progress” coach with the computer based portion of the system is depicted. Personal progress coaches are individuals who are typically employed by the system provider to make personal contact with the participants. Personal progress coaches may be any suitably trained individual. Exemplary personal progress coaches may be Registered Nurses or Health Educators, who have been trained to provide regular contact with participants over an extended period. A Health Educator may be a person with a Bachelor's degree, or equivalent experience, in a health education related field, such as Exercise and Sports Science, Community Health Education, Health Promotion, and Nutrition, with specific training in behavioral modification/cognitive coaching techniques. Where desirable, a physician responsible for a participant may be provided with coach-type access to the system for that participant.

As explained in box 700, a coach may log on to the computer based system, and login by selecting an appropriate command, such as by clicking a button on a webpage-like interface and entering a username and password, as explained in boxes 702 and 704. The coach may use a remote computer 50 to make contact with the participant tracking computer system 10. This may allow coaches to work from any location. For example, coaches may be allowed to work from a location of their choice, such as a residence, as well as from a more traditional office environment.

The coach may be allowed to access data relating to the participants assigned to that coach, this access may occur through a “top page” or main page interface, as explained in box 706, which may be a webpage-like interface accessed from interface database 30 and containing information from participant training database 25.

The coach may access various sets of information. For example, as explained at box 708, the coach home page may display, or the coach may select a command to display a set of “reminders” or a list of tasks to be accomplished. The details of any individual reminder or task may then be viewed by selecting it, as depicted in box 710. The reminders may be sorted by date, by type, or by the relative importance of the task. The reminders may be generated by the coach and saved during a login session, or may be automatically generated by the system from the goals entered by a participant or from data entered by an administrator. In this way, the reminders may be used by the system to determine the contact made by a coach with participants during a time period, such as a daily work-shift, a weekly period or over a month. It will be appreciated that the reminders may be displayed on a webpage-like interface as a “to-do” list or as a schedule or series of appointments on a calendar.

The coach may also access information relating to participants. Typically, the coach will be limited to viewing information associated with only the participants for whom they are responsible. As depicted in boxes 712, 714 and 716, the coach may access this information by selecting a list of the participants for which they are responsible, selecting an individual participant from that list and then viewing the information related to that participant. Webpage-like interfaces for allowing access to information associated with all assigned participants or for any particular participant may used. Training may be made available to the coaches through the system on various conditions or outcomes desired for participants, as explained in box 718. Such training may occur along the lines of any computer-based training known to those of skill in the art, including through the use of information displayed in webpage-like interfaces, accessed from interface database 30. For example, training modules may offer information to the coaches on the use of the computer based system (a Computer Module), on the progress and symptoms of diseases or conditions associated with participants for whom they are responsible (individual Pathology Modules), information on the coaching process or behavioral interventions (Cognitive/Behavioral Coaching Modules), and on the policy or procedures of their employment or other related matters.

Using the reminders or schedule provided by the computer-based portion of the system, coaches will engage in periodic contacts with the participants. These contacts may take place via email, telephone or as is otherwise appropriate or desired by the participant. The coach may collect information from the participant on the compliance with steps towards the goals selected for or by the participant. For example, where the participant has a goal of walking 15 minutes a day, the coach may call the participant on a weekly basis to enquire as to the participant's compliance. During the contact, the coach may obtain additional information from the participant relating to multiple goals, personal health or other interests. The coach may provide access to additional information on topics of interest to the participant, such as by providing information on community resources to the participant or by making information available through the computer-based portion of the system.

By using reminders, an individual coach may be able to schedule future contacts to be made to participants. Reminders for a specific time period, for example a day or week, may be displayed on calendar or schedule type display, when a user first logs on to the system 1. Reminders may be entered by an administrator, as discussed below and may provide the scheduling and work duties of individual coaches.

Where coaches are compensated on a time basis, the computer based portion of the system may also be used to calculate such time by serving as an electronic time sheet, where a coach's log in and end times are used to determine the time worked and are reported to an administrator. Where coaches are compensated on a basis of the number of contact made, or the number of participants for whom they are responsible, the computer based portion of the system may be used to track such information.

Where additional training of the coaches may be desired, as for example, the offering of in-service training or additional information with respect to specific health concerns, the computer based portion of the system may be used to provide such training. A reminder may be sent to a coach that a particular training unit on a medical concern is available over the computer based portion of the system. Alternatively, the training unit may be placed on the coaches “calendar” and made available during the appropriate session. The coaches may then be able to access the training unit using the system. For example, a training unit may be offered as a series of webpage-like interfaces containing information on a particular subject.

As contacts are made with the participants for whom the coach is responsible, the computer-based system may used to efficiently manage the contacts. For example, where a number of participants have similar, or the same goals, such as pre-assigned goals related to a shared health concern, the coach may be able to generate a list of such participants and compare progress to identify individuals that need additional coaching. Alternatively, the coach could use the list to generate a form email or letter to all such participants, containing information related to the goal, to the desired outcome, or reminding the participants to enter data to track their progress. The system may then personalize the form correspondence for each recipient, by inserting the participant's preferred name or other personal information as appropriate.

It will be appreciated that as contacts are made by the coach, or other tasks contained in the reminders completed, the coaches may indicate the performance of the task by entering a note or clicking a “complete” button on a webpage-like interface. This allows the computer based portion of the system to track the work performed by each coach and to keep track of the contacts made with the participants.

One advantage of the present system is the ability to use virtually any goal that is desired by a participant, as part of an overall effort to improve the participant's situation. For example, where the overall desired result with a participant is improved health, but the participant lacks motivation to address health care related goals, other goals important to the participant may be utilized. As an illustration, if the participant is an elderly individual with health concerns who is not motivated to address those concerns, as by exercising, but is slightly motivated to complete a hobby project (such as building a piece of furniture or making an item of clothing or other gift for a relative), the hobby project may be made a goal and the work and time spent on the project tracked. The coach provides contact and support related to this goal and the participant is able to track and view the completion of this goal. As the participant begins to achieve one goal, the coach can use the success to motivate the participant with respect to the participant's other goals.

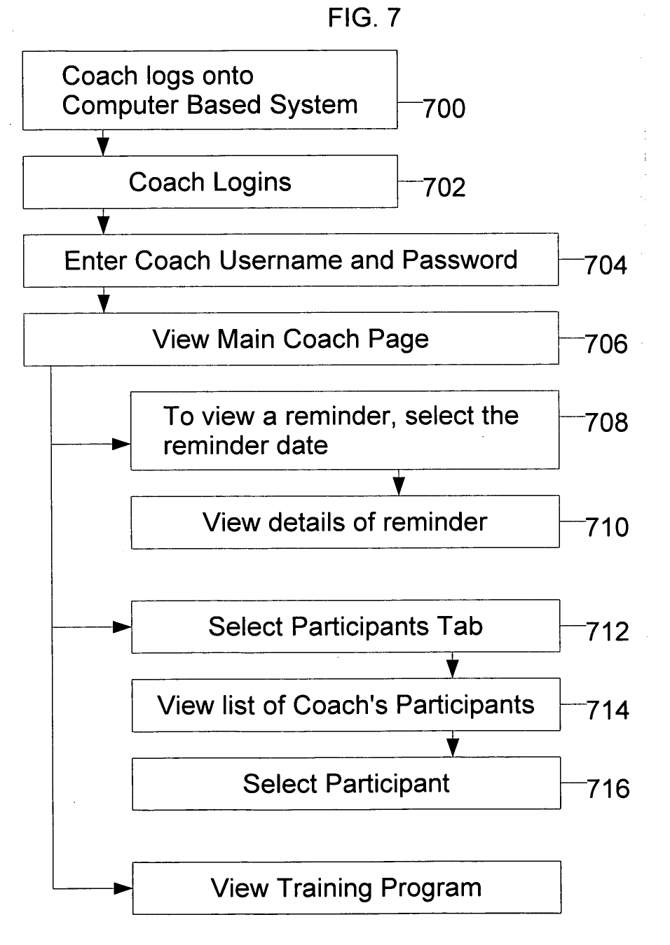

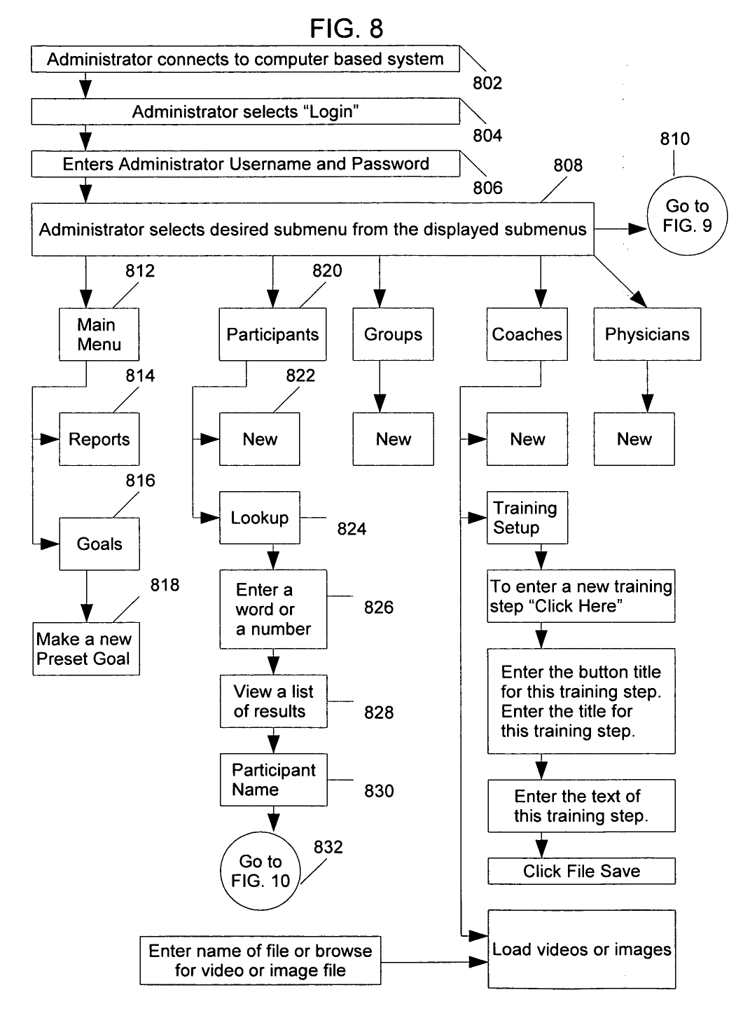

Turning to FIG. 8, a flowchart explaining the one embodiment of possible interactions of an administrator with the computer-based portion of the system is depicted. As explained at boxes 801 through 808, the administrator may connect to the system and login to arrive at a control interface. This may occur directly at the participant tracking system 10 or by using a remote computer 50 in communication therewith. From the control interface, a number of different options can be selected to control the system. For example, as depicted in box 810, the administrator may perform a search. FIG. 9 depicts a flowchart of how such searching may occur.

As depicted in FIG. 9, the administrator may pick a category for a search, as shown by box 902, which may be by reminder, message activity or new participant (as shown by boxes 904 through 910). The search may be filtered by an appropriate limitations (such as by score, group, participation, or username, as shown in boxes 912 through 918) and search the data contained in the participant tracking database 25 (as by selecting a “Search” button as shown in box 920. Filtering allows for searches to identify individual participants for intervention or increased contact by the coaches. It also allows for aggregate data related to specific interventions and outcomes to be analyzed. A single participant may be selected from a displayed list of search results, as shown in box 922.

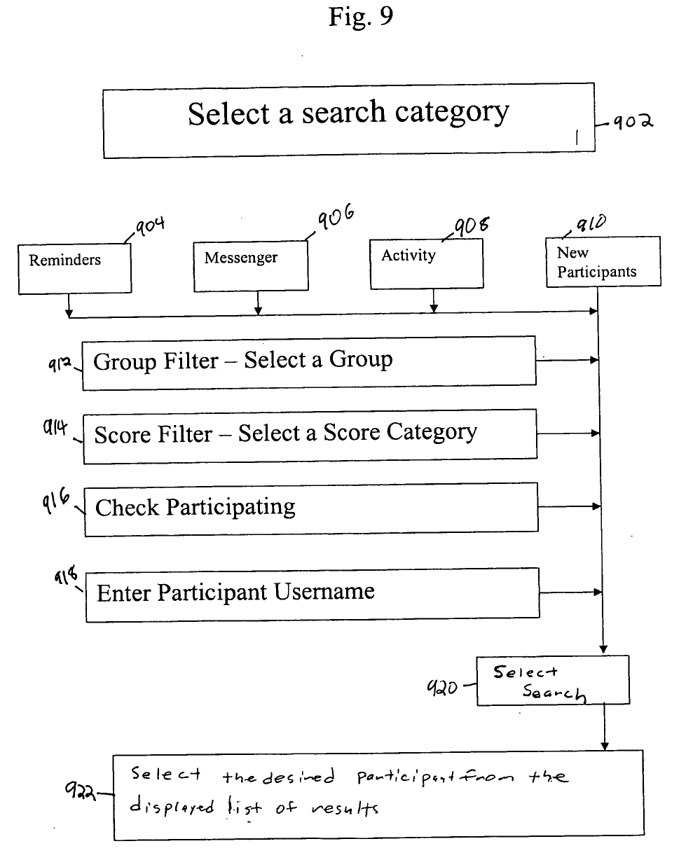

Returning to FIG. 8, as depicted in boxes 812 through 818, the administrator may generate reports on the system relating to goals for participants and may enter or revise preset goals. The administrator may also manage participants, as depicted in boxes 820 through 830 and the flowchart depicted in FIG. 10. The administrator may add new participants, or look up and manage current participants.

As depicted in FIG. 10, an administrator can input, modify or review information relating to the data maintained in the system for the participants. For the selected participant, the administrator is able to manage the assigned coaches (as shown in box 1002), to track the responsible physicians (as shown in box 1004), to track progress and data (as shown in boxes 1006-1010), to produce reports for individual participant or selected groups of participants (as shown in boxes 1012-1032) (this may allow tracking for participants by employer or health coverage, by types of conditions or by other groupings), to manage or add goals for a participant (as shown in boxes 1034-1042) (this may be to add goals prescribed by a physician or to assist participants by providing “technical support”), for scoring (as shown in boxes 1044-1046), to add additional reminders or scheduling (as shown in boxes 1048 and 1050), to revise the participant's health plan (as shown in boxes 1052-1054), and to maintain condition data (as shown in box 1056-1058). Using these controls journals for each participant and coach can be reviewed. The administrator can determine what information regarding the participant may be made available for various coaches responsible for that individual. For example, physicians may be provided coach level access to the system, and allowed access to information for participants who are their patients. This access may be limited to merely viewing the available data, or the physician may be able to make notes in a journal maintained by the system that can be viewed by the coach, but not the patient. Alternatively, the physician could participate as a regular coach and make contacts with the participant, as may be appropriate.

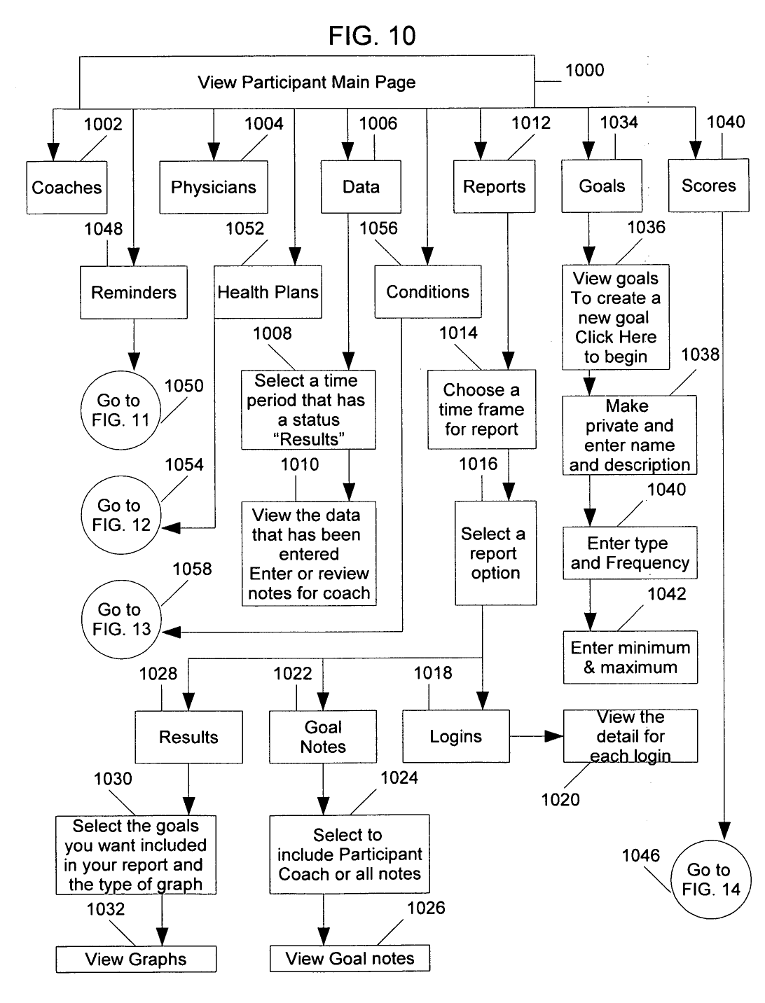

FIG. 11 depicts a flowchart describing how the administrators can enter reminders for the participants and the coaches using the computer-based portion of the system. It will be appreciated that this is in addition to the coach's and participants' ability to enter reminders, as may be appropriate for the goals and concerns associated with each participant. Reminders may be associated with the data on a participant maintained in the participant tracking database 25. As depicted in boxes 1100 through 1112, reminders may be entered by selecting appropriate buttons and data entry windows on one or more webpage-like interfaces. By using reminders, the administrator may schedule contacts for an individual coach to make with specific participants, schedule training for the coaches or provide information directly to participants. It will be appreciated that individual coaches may also schedule contacts to be made to participants for whom they are responsible. Reminders for a specific time period, for example a day or week, may be displayed on calendar or schedule type display, when a user first logs on to the system 1.

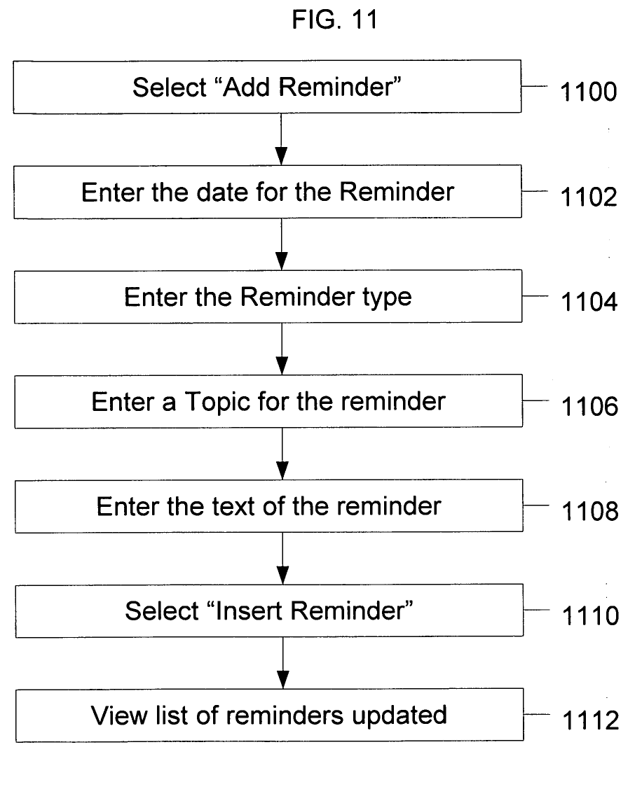

FIG. 12 depicts a flowchart describing how an administrator can enter health plan data into the system. As shown in boxes 1200 through 1206, the description, text and date of a health plan may be entered. Health plans may be action plans for individual participants, such as goals to address individual concerns. For example, where a participant is being treated by one or more health professionals such as general practice doctors, specialist doctors, physical therapists, mental health professionals, or other medical professionals, each practitioner's treatment plan for the participant can be added as a separate health plan. As information is gathered by the program, it may be furnished to those health professionals to aid on the development and customization of the participant's individual manner of care.

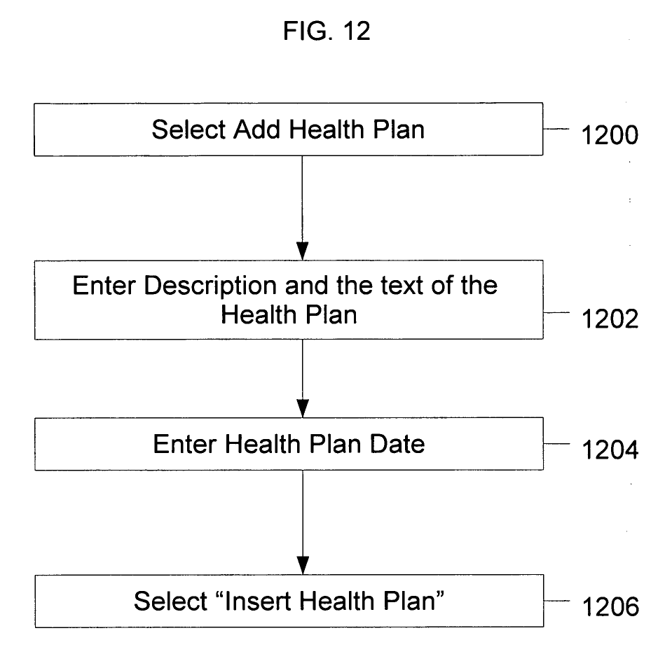

FIG. 13 depicts a flowchart describing how an administrator may enter health condition data regarding the participants. As shown by boxes 1300 through 1308, conditions may be selected and specific information related to each participant input into the system. For example, where a participant has concerns related to high blood pressure, this condition may be selected and individual scores and factors for the participant may be input. This allows the coaches to monitor such factors and the concern as part of the contacts with the participant.

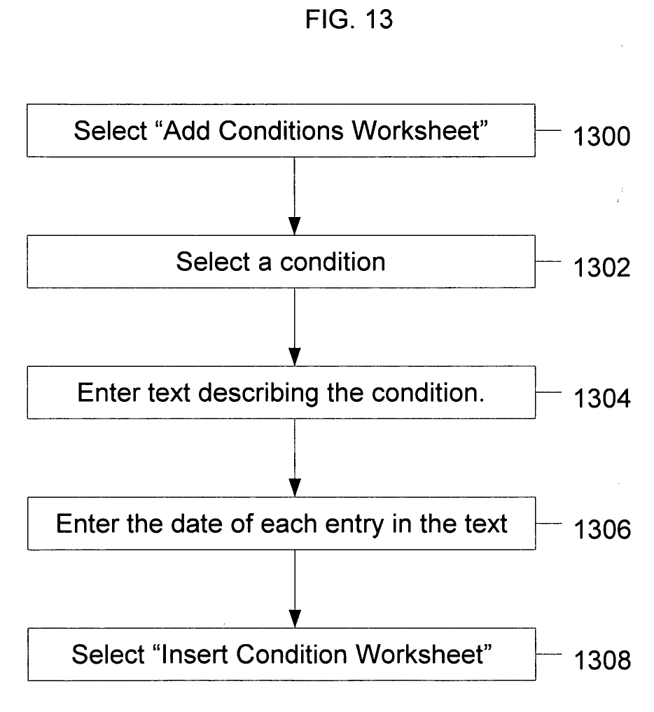

FIG. 14 depicts a flowchart describing how the administrators can generate and manage score sheets. The score sheets may include various categories or different assessments that may be used by the coaches to score and track the participants. Score sheets may be used to track the progress of individual participants or to track the system against categories of concern, including customer satisfaction or claims data, in addition to specific health care concerns.

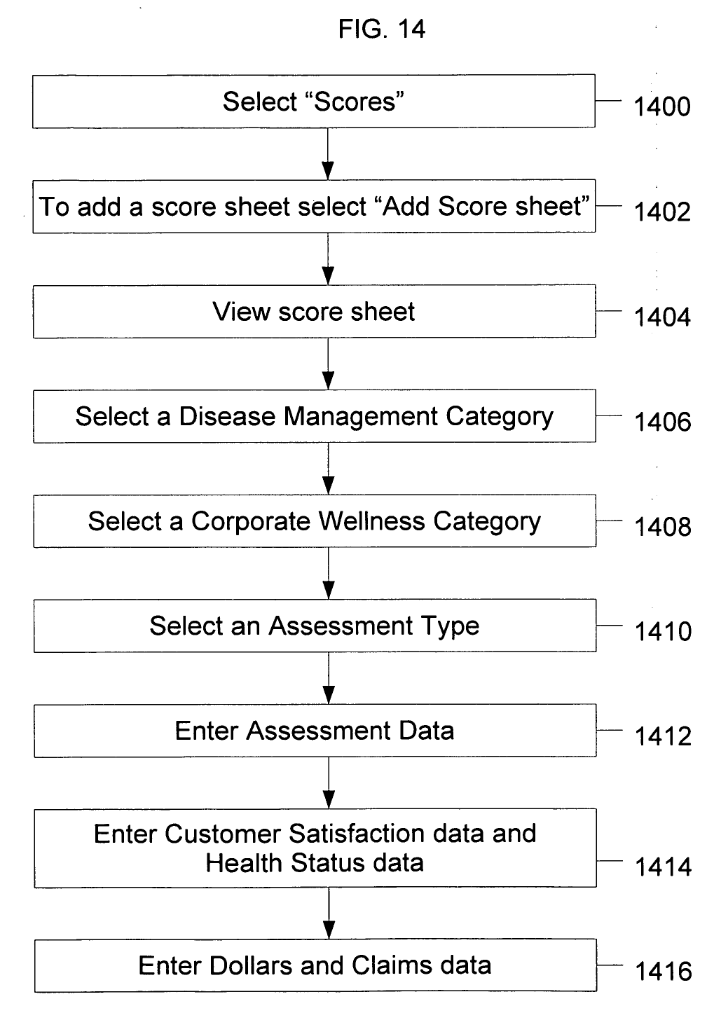

FIG. 15 depicts a flowchart of one embodiment of a way in which a system user may create and send an internal message to another user of the computer based portion of the system. For example, a participant may desire to send a message to a behavioral modification coach they are working with in order to ask a question, or a behavioral modification coach need to communicate with a participant, an administrator or health care professional with access to the system. The send message function may thus be available to all users of the system, although participants and coaches may be restricted in whom they are allowed to send messages too in order to protect participant information in accordance with HIPAA guidelines.

As shown in box 1500, the user selects a send message command, and then enters a subject for a message in a subject box (as shown at 1502) and the text of the message in a text box (as shown at 1504). The message may then be sent by selecting a send message command, as shown at box 1506. The receiving user may then be provided with the message, if currently logged into the system, or may be provided with the message upon their next access of the system. It will be appreciated that messages may be displayed in a webpage-like interface similar to web-based email. If a user does not desire to send a message that is in the process of being created, the user can cancel the message.

The system of the present invention may be used to target a number of different individuals, as may be appropriate. In one example, Physically Healthy and Motivated: Access to Health Coaching-Access to telephonic personal health coaching may made be made available by appointment for all members. Participants can call and schedule a telephonic appointment with a personal health coach who can assess their current health behaviors and help them design a self-care plan to maximize their health and quality of life. In a second example, which may be known as the Physically Healthy and Motivationally Challenged: Wellness Coaches may be used to support participants with risk factors identified through health assessments. Insurance premium discounts or other incentives may be used to motivate participation. Participants and/or their family members who fail to meet an established health standard, may work with a personal health coach to create and unique alternative standard that they can meet. They then track their alternative standard participation levels and work with a personal health coach to continue receiving their premium discounts or other incentives. In addition to discounts on an insurance premium, other incentives may be used, such as the employer making a contribution to a Health Reimbursement Account for the participant, providing a cash bonus, or additional vacation hours or other incentives to the participant.

In a third example, known as for the group identified as the Persistently III but Motivated: At-Risk Disease Management-Identifying chronically ill members through claims analysis and patient profiling strategies. Proactively proving the support of a personal health coach to enhance personal self-care strategies through teaching behavioral change skills and focusing on the hopes and desires of the patient. Also, providing care coordination with the patients treatment team to ensure full collaboration. In a fourth example, the Persistently Ill and Motivationally Challenged: The 1% Solution—the same as the At-Risk Disease Management program, but specifically for the highest-utilizing group of chronically ill members within the population.

One advantage of the present invention over current systems is the customizability, which allows the benefits to be tailored for specific implementations. Other current systems offered as bona fide wellness programs or disease management programs offer only single implementation that may be implemented in conjunction with a health insurance plan. Since systems offer only a single implementation at a single fixed cost, it may not be possible for such plans to be implemented for many groups which desire the cost containment available from offering such programs. The present invention allows for customized benefits provided by a single system, which can thus provide benefits for multiple groups seeking to implement such plans.

For example, in a disease management implementation, different embodiments of the present invention may offer the intensive intervention including behavior coach support, discussed elsewhere herein, to those achieving different scores on the health assessment, or having different conditions in the review of past health conditions. This would alter the percentage of individuals in the concerned group (such as a health insurance plan pool) who are participating in the disease management system in accordance with the present invention. Accordingly, the costs to operate the plan may be adjusted.

Similarly, the specific benefits made available to participants using the system may be individually tailored. For example, the number of contacts between a coach and a plan participant to discuss progress on any goal, and/or the type of such contacts (whether telephonic, by email, or in-person) may be adjusted. The number of goals tracked and reporting periods may similarly be adjusted to arrive at a level of desired benefits and costs acceptable to a potential purchaser of the system. Since the computer based portion of the system may be utilized to control the work flow and schedules of the coaches as well as the access by the participant, the changing of these parameters may be entered into the computer based system by an administrator.

While this invention has been described in certain embodiments, the present invention can be further modified with the spirit and scope of this disclosure. This application is therefore intended to cover any variations, uses, or adaptations of the invention using its general principles. Further, this application is intended to cover such departures from the present disclosure as come within known or customary practices in the art to which this invention pertains and which fall within the limits of the appended claims.

What is claimed is:

1. A method of providing a behavioral modification program to a subject, the method comprising:
providing the subject with access to a computer-based behavior-modification management system to allow the subject to track progress on a selected goal, wherein the computer-based behavior-modification management system maintains information on the subject to allow a behavioral modification coach to track progress and to schedule contacts with the subject;
requiring the subject to create a goal of the subject's choice and input the chosen goal into the computer-based behavior-modification management system for tracking;
requiring the subject to enter information into the computer-based behavior-modification management system for tracking compliance of the subject's behavior associated with the chosen goal; and
monitoring the compliance of the subject's behavior associated with the goal.

2. The method according to claim 1, wherein requiring the subject to create a goal of the subject's choice and input the chosen goal into the computer-based behavior-modification management system for tracking comprises requiring the subject to create a goal which requires the user to perform actions that lead to an improved health condition.

3. The method according to claim 1, wherein requiring the subject to create a goal of the subject's choice and input the chosen goal into the computer-based behavior-modification management system for tracking comprises requiring the subject to create a goal which does not require the user to perform actions related to improving or maintaining a health condition.

4. The method according to claim 1, wherein requiring the subject to enter information into the computer-based behavior-modification management system for tracking compliance of the subject's behavior associated with the chosen goal comprises requiring the subject to enter information on a predetermined periodic basis.

5. The method according to claim 1, wherein requiring the subject to enter information into the computer-based behavior-modification management system for tracking compliance of the subject's behavior associated with the chosen goal comprises having the subject enter information into a remote computer in communication with the computer-based behavior-modification management system, or report the information to a behavior modification coach for entry into the computer system.

6. The method according to claim 1, wherein monitoring the compliance of the subject's behavior associated with the goal comprises tracking the compliance of the behavior over a given time period.

7. The method according to claim 6, wherein tracking the compliance of the behavior over a given time period comprises discussing the compliance with a behavioral modification coach.

8. The method according to claim 7, wherein discussing the compliance with a behavioral modification coach comprises communicating with the coach by telephone or by transmitting messages over a computer network.

9. The method according to claim 6, wherein tracking the compliance of the behavior over a given time period comprises providing reports to the subject summarizing compliance over a given time period.

10. The method according to claim 1, wherein providing the subject with access to a computer-based behavior-modification management system to allow the subject to track progress on a selected goal, wherein the computer-based behavior-modification management system maintains information on the subject to allow a behavioral modification coach to track progress and to schedule contacts with the subject comprises providing the subject with access to a computer-based behavior-modification management system to which a behavioral modification coach is allowed access to maintain information on the subject.

11. The method according to claim 10, wherein providing the subject with access to a computer-based behavior-modification management system to which a behavioral modification coach is allowed access to maintain information on the subject comprises providing the subject with limited access to a computer-based behavior-modification management system which is used to manage contact between the behavior modification coach and the subject.

12. The method according to claim 11, wherein providing the subject with limited access to a computer-based behavior-modification management system which is used to manage contact between the behavioral modification coach and the subject comprises providing access to a computer-based behavior-modification management system which is configured to remind the behavioral modification coach to contact the subject on a periodic basis for support of the selected goals and to record and manage notational information on the subject's progress input by the coach.

13. The method according to claim 1, wherein providing a subject with access to a computer-based behavior-modification management system to allow the subject to track progress on a selected goal comprises providing every participant in a health plan with access to the computer-based behavior-modification management system as part of a wellness program.

14. The method according to claim 13, wherein providing every participant in a health plan with access to the computer-based behavior-modification management system as part of a wellness program further comprises providing those participants who utilize the computer-based behavior-modification management system with an incentive for utilizing the wellness program.

15. The method according to claim 14, wherein providing those participants who utilize the computer-based behavior-modification management system with an incentive for utilizing the wellness program initial comprises providing an initial discount on an insurance premium in exchange for accessing the computer-based behavior-modification management system as an initial utilization of the wellness program

16. The method according to claim 15, further comprising providing those participants who continue to utilize the computer-based behavior-modification management system with a subsequent discount on an insurance premium in exchange for continued utilization of the computer-based behavior-modification management system.

17. The method according to claim 1, wherein continued utilization of the computer-based behavior-modification management system is defined as actively tracking a goal for at least a portion of a year.

18. The method according to claim 1, wherein providing a subject with access to a computer-based behavior-modification management system to allow the subject to track progress on a selected goal comprises:
identifying specific individuals participating in a health care plan as potential high utilizers of health care services who are motivationally challenged;
establishing contact between the identified individuals and behavioral modification coaches;
making the computer-based behavior-modification management system available to the behavioral modification coaches and the identified individuals to allow the identified individuals to track their progress on selected goals and receive instruction and support from the behavioral modification coaches as part of a disease management program.

19. A method of managing a behavioral modification program, the method comprising:
providing a computer-based behavior-modification management system to allow at least one subject to track progress on a selected goal and to maintain information on the at least one subject and to manage the work of a behavioral modification coach;
requiring the at least one subject to create a goal selected by the subject and enter information into the computer-based behavior-modification management system for tracking compliance of the subject's behavior associated with the selected goal; and
managing the behavioral modification coach by scheduling the contacts to be made by the behavioral modification coach with the at least one subject.

20. The method according to claim 19, wherein providing a computer-based behavior-modification management system to allow at least one subject to track progress on a selected goal and to maintain information on the at least one subject and to manage the work of a behavioral modification coach comprises providing a computer-based behavior-modification management system requiring the at least one subject to create a goal which leads to an improved health condition.

21. The method according to claim 19, wherein providing a computer-based behavior-modification management system to allow at least one subject to track progress on a selected goal and to maintain information on the at least one subject and to manage the work of a behavioral modification coach comprises providing a computer-based behavior-modification management system requiring the at least one subject to create a goal which does not require the at least one subject to perform actions related to improving or maintaining a health condition.

22. The method according to claim 19, wherein requiring the at least one subject to enter information into the computer-based behavior-modification management system for tracking compliance of the at least one subject's behavior associated with the chosen goal comprises having the at least one subject enter information into a remote computer in communication with the computer-based behavior-modification management system, or report the information to a behavioral modification coach for entry into the computer system.

23. The method according to claim 19, wherein managing the behavioral modification coach by scheduling the contacts to be made by the behavioral modification coach with the at least one subject comprises utilizing reminders generated by the computer-based behavior-modification management system to schedule the contacts on a periodic basis for support of a selected goal.

24. The method according to claim 23, wherein the reminders generated by the computer-based behavior-modification management system are input therein by the behavioral modification coach in a prior session.

25. The method according to claim 19, wherein the computer-based behavior-modification management system is further configured to and manage notational information on the at least one subject's progress input by the behavioral modification coach.
